(19) United States
(12) Patent Application Publication
(10) Pub. No.: US 2016/0162955 A1
(43) Pub. Date: Jun. 9, 2016

(54) MODULATING BUDGET SPENDING PACE FOR ONLINE ADVERTISING AUCTION BY ADJUSTING BID PRICES

(71) Applicant: AppNexus, Inc., New York, NY (US)

(72) Inventors: Charles B. O'Kelley, New York, NY (US); Catherine M. Williams, New York, NY (US); Taylor E. Burmeister, New York, NY (US)

(21) Appl. No.: 14/561,615

(22) Filed: Dec. 5, 2014

(51) Int. Cl. G06Q 30/02

(52) U.S. Cl. CPC G06Q 30/0275

(57) ABSTRACT

Methods, systems, and apparatus, including computer programs encoded on a computer storage medium, for identifying a plurality of auction elements, each auction element comprising one or more ad spaces on web pages, identifying an advertising element, the advertising element comprising an advertiser and one or more campaigns, each campaign comprising one or more creative elements, submitting the advertising element to bid on available ad spaces of the auction elements during a first time period, using a respective first bid price for each particular auction element, determining a first budget spending pace of the advertising element for the first time period based on a number of impressions served by one or more creative elements of the advertising element on the auction elements during the first time period, determining a target budget spending pace of the advertising element for a second time period after the first time period, and determining a second bid price for each particular auction element for the second time period, based on the target budget spending pace, the first budget spending pace, and the first bid price for the particular auction element.

### BACKGROUND

This specification relates to advertising and, in particular, adjusting bid prices for auctions of online advertising spaces.

Online display advertising delivers promotional messages to consumers by using visual advertisements (or “ads”) in web pages. A publisher of a web page can insert an ad space in the web page. When the web page is displayed in a browser, a visual advertisement (a “creative”) of an advertiser can be dynamically retrieved from an ad server for the advertiser, and displayed in the ad space. The act of displaying or serving a creative on a web page is often referred to as an impression.

An ad inventory is a collection of one or more ad spaces on web pages served by a publisher's web sites. Publisher can sell their ad inventories to advertisers. Multiple publishers and multiple advertisers can participate in auctions in which selling and buying of ad inventories take place. Auctions can be conducted by an ad network or ad exchange that brokers between a group of publishers and a group of advertisers.

Selling and buying ad spaces can be based on pricing or payment models such as cost per thousand impressions (CPM), cost per click (CPC), and cost per action or acquisition (CPA). In the CPM model, advertisers typically pay for every impression of their advertisement, the price paid for each impression is measured in price per 1000 (“mille”) impressions. In the CPC model, advertisers typically pay each time a viewer clicks on their advertisement. In the CPA model, advertisers pay for every action, such as a sale or registration, completed as a result of a viewer clicking on their advertisement.

### SUMMARY

In general, one aspect of the subject matter described in this specification can be embodied in methods that include the actions of identifying a plurality of auction elements, each auction element comprising one or more ad spaces on web pages, identifying an advertising element, the advertising element comprising an advertiser and one or more campaigns, each campaign comprising one or more creative elements, submitting the advertising element to bid on available ad spaces of the auction elements during a first time period, using a respective first bid price for each particular auction element, determining a first budget spending pace of the advertising element for the first time period based on a number of impressions served by one or more creative elements of the advertising element on the auction elements during the first time period, determining a target budget spending pace of the advertising element for a second time period after the first time period, and determining a second bid price for each particular auction element for the second time period, based on the target budget spending pace, the first budget spending pace, and the first bid price for the particular auction element. Identifying, submitting, and determining can be performed by one or more computer processors. Other embodiments of this aspect include corresponding systems, apparatus, and computer programs.

These and other aspects can optionally include one or more of the following features. A second bid price for each particular auction element for the second time period can be determined further based on an adjustment providing more weight to a first condition or a second condition. A first condition can be configured to enable, with the second bid price, a higher number of success events from impressions served by one or more creative elements of the advertising element on the auction elements during the second time period. A second condition can be configured to enable, with the second bid price, a higher margin from impressions served by one or more creative elements of the advertising element on the auction elements during the second time period. The target budget spending pace can be determined based on a remaining budget and remaining effective duration of the advertising element after the first time period. The target budget spending pace can be determined based on time of day of the second time period. Determining a second bid price for each particular auction element for the second time period can be further based on an expected revenue generated from success events on impressions served by one or more creative elements of the advertising element on the particular auction element. Determining a second bid price for each particular auction element for the second time period can be further based on an expected number of success events on impressions served by one or more creative elements of the advertising element on the particular auction element. A particular success event can be a click event or click-through event.

Particular implementations of the subject matter described in this specification can be implemented to realize one or more of the following advantages. The system described herein modulates ad budget spending pace for online advertising auctions. With a given budget, instead of bidding on ad inventories in limited windows in time, the system bid on the ad inventories continuously in time. The system modulates ad spending pace to fit within the given budget by continuously bidding while dynamically adjusting bid prices on the ad inventories. In this way, the system does not miss out impressions or success events from ad inventories outside bidding windows. The system can further adjust bid prices to optimize for a higher total revenue or a higher margin from impressions from the ad inventories.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 illustrates an example system for adjusting bid prices for online advertising auctions.

FIG. 2 is an example data flow diagram for a system for adjusting bid prices for online advertising auctions.

FIG. 3 is a flow chart of an example method for adjusting bid prices for online advertising auctions.

### DETAILED DESCRIPTION

A success event from an impression can be a click event, a click-through event (e.g., an action after a click event), or a view-through event (e.g., an action after viewing an impression). Other success events are possible. A success event from an impression can indicate an ad buyer's own web content (e.g., a landing page for a click event) is consumed by the viewer of the impression, or actions desired by the buyer is taken by the viewer. For instance, the viewer can take actions such as joining a mailing list, creating an account, completing a survey, purchasing an item, saving an item to a wish list, sharing content on a landing page to a friend, subscribing to a web feed, and so on. For a buyer of ad inventories, it is often desirable to pay for lowest possible price per success event, or lowest possible CPA or CPC, for a given budget. For a buyer of ad inventories, it can also be desirable to pay for lowest possible price per impression, or lowest possible CPM, to attract more “eyeballs” on the buyer's ads for a given budget, for example.

A buyer of ad inventories can optimize the results from ad spaces the buyer purchases by adjusting bid prices on different ad inventories. For instance, to optimize for more success events, a buyer can bid with a higher bid price for an ad inventory that can potentially (e.g., based on historical data) generates more success events per impression, and bid with a lower bid price for another inventory that may potentially generates less success events per impression. Meanwhile, bidding on ad inventories can be constrained by budgets (e.g., a daily budget) available to the buyer.

Ordinarily, a buyer can limit ad spending within a budget by limiting the time or the number of ad inventories to bid on. For instance, the buyer can bid on ad inventories during a day (e.g., starting 7 o'clock in the morning) until all available daily budget is spent. The buyer can also spread out ad buying throughout a day by bidding on ad inventories in intervals. For instance, the buyer can bid on ad inventories for a 20-minutes window every hour such that the ad buying can fit into the daily budget limit. However, the buyer misses out on ad inventories that may provide good return (e.g., higher number of impressions or success events per unit cost) but fall outside the bidding windows.

Instead of missing out on viable ad inventories, particular implementations of the subject matter describe methods for bidding on available ad inventories but still fitting within an available budget. The system modulates ad spending pace by dynamically adjusting bid prices on different ad inventories. The system submits bids on ad inventories for a first time period, and determines a first budget spending pace for the first time period. For a second time period after the first time period, the system determines an target budget spending pace for the second time period, and determines bid prices on the ad inventories based on bid prices for the first time period, the first budget spending pace, and the target budget spending pace for the second time period. The system also adjusts bid prices to enable a higher margin on the ad inventories, or a higher number of success events from impressions on the ad inventories, for the second time period.

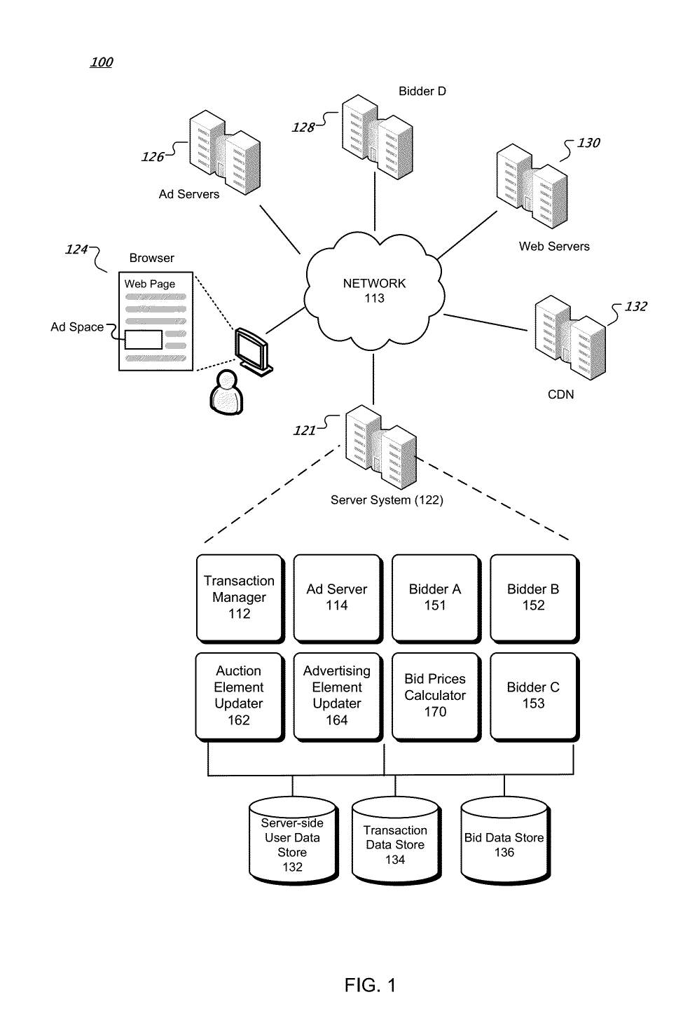

FIG. 1 illustrates an example system for adjusting bid prices for online advertising auctions. A server system 122 provides functionality for adjusting bid prices for online advertising auctions. The server system 122 comprises software components and databases that can be deployed at one or more data centers 121 in one or more geographic locations, for example. The server system 122 software components comprise a transaction manager 112, ad server 114, and one or more bidders (e.g., bidder A 151, bidder B 152, bidder C 153). The server system 122 software components also comprise an auction element updater 162, advertising element updater 164, and bid prices calculator 170. The server system 122 can also include one or more software components for load balancing tools and security tools. The load balancing tools manage traffic within a single data center or between multiple data centers. The security tools manage data protection and access privilege for tenants served by the data centers 121. The software components can comprise subcomponents that can execute on the same or on different individual data processing apparatus. The server system 122 databases comprise a server-side user data store database 102, transaction data store database 134, and bid data store database 136. The databases can reside in one or more physical storage systems. The software components and data will be further described below. The transaction manager 112 (“impression bus” or simply “Imp Bus”) is a software component that facilitates the transaction aspects of ad inventory trading between buyers and sellers. A buyer can be an advertiser (e.g., Visa Inc., Adidas AG), an ad network (e.g., DoubleClick of Google, Inc., Bing Ads of Microsoft Corporation), or an advertising agency (e.g., OMG National). Other buyers are possible. A seller can be a publisher (e.g., The Washington Post, CNBC, Facebook), an online streaming or gaming service (e.g., Hulu, Xbox Live of Microsoft Corporation), or an ad network. Other sellers are possible. The transaction manager 112 processes ad requests received from browsers displaying content from publishers, feeds data to advertisers, conducts auctions (e.g., on behalf of sellers), returns creatives to the browsers, keeps track of billing and usage for advertisers and publishers, returns auction-result data, and enforces quality standards, for example. The transaction manager 112 stores in the transaction data store database 134 various transaction information for each and every ad space that is transacted by the transaction manager 112 or other software components of the server system 122.

The ad server 114 is a software component that serves ads or creatives to web pages. The ad server 114 can also make decisions about what ads to be served, track clicks on ads and other data, for example.

A bidder (e.g., bidder A 151) is a software component that, on behalf of a buyer, performs bidding operations. The bidder takes various pieces of bid-specific information (e.g., maximal bid price, target user areas or segments, start and end dates, budget) as input and generates a bid for a particular item of an ad inventory, for example. The bidder may store bid-specific information in bid data store database 136.

The transaction manager 112 can conduct an auction when receiving an ad request. By way of illustration, a web page of a publisher can include an ad tag for an ad space on the web page. The ad tag includes a URL (e.g., URL for the server system 122) from which an ad will be requested, and HTML or JavaScript codes for instructing a browser how to display the ad (e.g., displaying the ad in a 160×600 iframe). A browser 124 running on a user's client device (e.g., a desktop or laptop computer, a tablet computer, a mobile phone, a game console, an in-car media system) can retrieve the web page through one or more data communication networks 113 such as the Internet, for example, from web servers 130 of the publisher. The ad tag causes the browser to send (e.g., through the networks 113) an ad request to the server system 122. The ad request can include information about the ad space (e.g., a size for the ad space, an identifier for the publisher), user information (e.g., an identifier of the user, an IP address), and system information (e.g., types of the browser and the client device), for example.

In response to the ad request, the transaction manager 112 can access a server-side user data store database 132 based on the user's identifier (if available), and retrieve available information about the user (e.g., user segment information such as age, gender, interests, or location). The transaction manager 112 generates a bid request including information about the ad space, the user, and so on, and sends the bid request to multiple bidders such as bidder A 151 and bidder B 152. The transaction manager 112 can also send the bid request through the networks 113 to servers of bidder D 128, which is external to the server system 122.

Each bidder can base on its own requirement (e.g., budget, targets in placements or user demographics) and submits a bid response including a bid price and an identifier of a creative to be served, for example, to the transaction manager 112 (or not to respond at all). The transaction manager 112 determines a winning bid (e.g., a highest bid) among bid responses received within a specified time period (e.g., 10 milliseconds). The transaction manager 112 then returns a URL for a creative of the winning bid to the user's client device, causing the browser to retrieve the creative from an ad server (e.g., ad server 114, or ad servers 126 external to the server system 122 ), or from servers of a content distribution network (CDN) 132.

The auction element updater 162 is a software component that identifies an auction element for an auction. An auction element can be an ad inventory—i.e., a collection of one or more ad spaces on one or more web pages. An auction element can also be one or more ad spaces within user interfaces of one or more software application (e.g., a game applications).

Other collections of ad spaces for auction elements are possible. By way of illustration, an auction element can comprise a collection of one or more ad spaces (e.g., identified by ad tags) on web pages served by a seller's web site. The seller can group a set of web pages by its liking for an auction, as the seller may have the best understanding of web pages on its web properties. For instance, the seller can group a particular set of web pages related to basketball (e.g., from websites covering scores and news of basketball games) for an auction. This particular set of web pages (a “placement group”) can offer a better targeting of impression viewers who are interested in basketball or sports (e.g., for an advertiser of sporting goods), and potentially has higher success rate from impressions on this particular set of web pages. The seller can submit an auction element to the transaction manager 112 (or another software component of the server system 122) via an auction element application programming interface or API, causing the transaction manager 112 to store the auction element in the bid data store database 136, for example. The auction element updater 162 can identify an auction element by listening to the auction element API, or periodically checks the bid data store database 136, for new auction elements.

As for another example, the auction element updater 162 can access the bid data store database 136 for ad spaces from one or more sellers, and group the ad spaces into auction elements. Each auction element (a “venue”) can have similar attributes (e.g., user target geographical area, domain, application, and so on). The auction element updater 162 can also group ad spaces into auction elements such that each auction element has similar historical performance characteristics (e.g., similar numbers of impressions for a unit time, or similar CPM, CPC, or CPA).

The advertising element updater 164 is a software component that identifies a plurality of advertising elements that will bid on auction elements. An advertising element or line item includes one or more advertising campaigns for an advertiser (a buyer). A line item can be a financial agreement with an advertiser that includes effective start and end dates (“flight dates”) and a budget (e.g., lifetime budget, daily budget). A line item can also include performance goals (e.g., based on CPC or CPA payment model) that can be used to determine whether or not to bid on an ad inventory. A line item can also include one or more conversion pixels that are used to track revenue or performance goals. A line item can also include targets such as devices (e.g., desktop and laptop computer, tablet computer, mobile phone), placements (e.g., desktop and laptop web page, mobile web page, mobile application), domains (e.g., web domains, mobile applications, websites), user geographic areas, or user systems (e.g., carriers, operating systems, browsers, devices). Other line item targets are possible. A line item can also include on or more creatives.

Each advertising campaign of a line item includes a set of creatives that promote an idea, theme, product, or brand (e.g., a children's brand, a healthy lifestyle, a new car model). Similarly to a line item, an advertising campaign can include flight dates and a budget. An advertising campaign also includes one or more payment types (e.g., CPC, CPM, CPA) and bidding instructions (e.g., a bid price) on ad inventories, and one or more creatives. An advertising campaign can also include targets in devices, placements, domains, user geographic areas, user systems. An advertising campaign can have more granular controls in targeting than a line item, such as targets in inventory segments (e.g., automobiles, home and garden, sports), publishers, and user segments (e.g., demographics). Other advertising campaign targets are possible.

In some implementations, a line item may have precedence over its advertising campaigns. For instance, an advertising campaign cannot bid after its parent line item's flight dates had expired. In some other implementations, an advertising campaign may have precedence over its parent line item. For instance, if an advertising campaign's user target geographic area is smaller than but is part of the user target geographic area of its parent line item, the advertising campaign will bid only within its own user target geographic area. In yet some other implementations, an aggregation of targets or creatives of a line item and its advertising campaigns can be used to bid on an auction element or ad inventory.

A buyer (e.g., an advertiser or an ad network) can submit a line item including one or more advertising campaigns to a bidder (e.g., bidder A 151) through a line item API, causing the bidder to store the line item in the bid data store database 136. The advertising element updater 164 can identify new line items by listening to the line item API, or periodically check the bid data store database 136 for new line items.

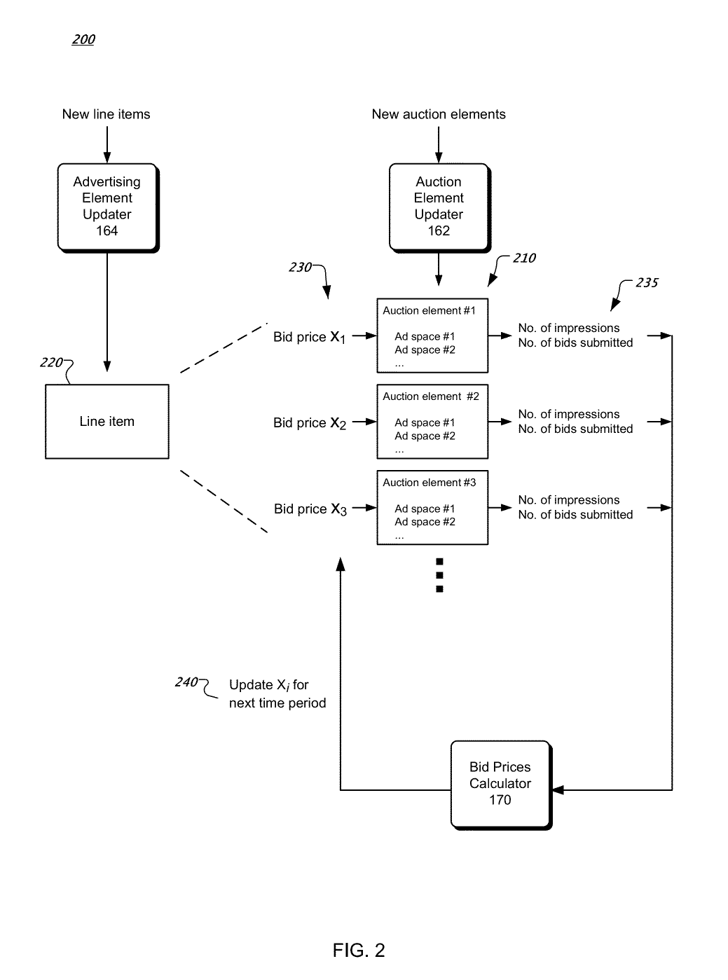

The bid prices calculator 170 is a software component that calculates, for a line item (an advertising element), bid prices to bid one different auction elements. The bid prices calculator 170 is described in further detail below in reference to FIG. 2.

FIG. 2 is an example data flow diagram for the system illustrated in FIG. 1. The auction element updater 162 obtains a plurality of auction elements 210 (e.g., auction element #1, auction element #2, auction element #3, and so on). Each auction element comprises one or more ad spaces.

The advertising element updater 164 receives a new line item 220 (e.g., from an ad buyer or and ad network). The line item 220 comprises one or more advertising campaigns, and a budget (e.g., a daily budget, or lifetime budge). Each advertising campaigns comprises one or more creatives. Here, let xᵢ denote the line item's bid price for ad spaces of the i-th auction element, and let that there are n total auction elements: i=1, 2, . . . , n. A bidder (e.g., bidder A 151) can submit respective bid prices xᵢ (230) to bid on the auction elements 210. Each bid price xᵢ can be specific to a particular campaign and creative of the line item.

How much the line item can bid on the auction elements—i.e., the bid prices xᵢ, is limited by available budget of the line item. Here, let S denote a budget spending pace, or a budget to be spent during a time period. S can be a number of impressions that the line item won bidding during the time period. In some implementations, S can be the total media cost (the sum of second price bids paid) for bids won during the time period.

Let Eᵢ denote the number of ad spaces of the i-th auction element that are available for the line item to bid for a unit of time. Let Fᵢ(xᵢ) denote a win curve—i.e., a probability that the bid price xᵢ would be the winning bid for a given ad space of the i-th auction element. Let vᵢ denote an expected value of an impression for the line item on the i-th auction element—i.e., a probability of a success event from the impression, multiplied by a value of the success event (e.g., a price paid by an advertiser for the success event). Let cᵢ denote an expected cost of an impression on the i-th auction element given the bid price xᵢ. Assuming second-price auctions are conducted on the auction elements, the expected cost of an impression on the i-th auction element cᵢ is the expected highest competing bid if the line item wins the auction for the i-th auction element.

Optimizing the total (expected) revenue for the line item can be represented as maximizing the following utility function

$${\sum }_{i = 1}^{n} {E}_{i} \cdot {F}_{i} ( {x}_{i} ) \cdot ( {v}_{i} - {c}_{i} ( {x}_{i} ) ) ,$$

subject to a constraint in how much the line item can bid on the auction elements:

$${\sum }_{i = 1}^{n} {E}_{i} \cdot {F}_{i} ( {x}_{i} ) = S$$

Solving the above optimization problem can be equivalent, based on the method of Lagrange multipliers, to optimizing the follow:

$$Λ ( {x}_{1} , {x}_{2} , … , {x}_{n} , λ ) = {\sum }_{i = 1}^{n} {E}_{i} \cdot {F}_{i} ( {x}_{i} ) \cdot ( {v}_{i} - {c}_{i} ( {x}_{i} ) ) - λ ( {\sum }_{i = 1}^{n} {E}_{i} \cdot {F}_{i} ( {x}_{i} ) - S )$$

for a multiplier λ. In a second-price auction, the cost of an impression is the second highest bid made, and thus the expected cost on an impression for a given bid price is the expected value of the second highest bid when the given bid price wins the auction. In other words, c(x)=E[y|y<x], where y is the highest competing bid. By definition,

$$E [ y \vert y < x ] = {\int }_{0}^{x} y \cdot Pr ( y \vert y < x ) d y .$$

By Bayes' theorem,

$$Pr ( y \vert y < x ) = \frac{Pr ( y < x \vert x ) \cdot Pr ( y )}{Pr ( y < x )} .$$

Here, Pr(y<x|y) is 0 if y≧x, and 1 if y<x. Here, let f denote the derivative of F. Thus Pr(y)=f(y), and Pr(y<x)=F(x). Therefore,

$$c ( x ) = {\int }_{0}^{x} y \frac{f ( y )}{F ( x )} d y = \frac{1}{F ( x )} {\int }_{0}^{x} yf ( y ) d y .$$

Thus for second-price auctions, the derivative of Fᵢ(xᵢ)·cᵢ(xᵢ) is fᵢ(xᵢ)·xᵢ, wherein fᵢ(xᵢ) is the derivative of Fᵢ(xᵢ). Taking partial derivatives and setting them equal to zero yields the following

Eᵢ·fᵢ(xᵢ)·(vᵢ−xᵢ)−λ·Eᵢ·Fᵢ(xᵢ)=0

for each i-th auction element. Thus each bid price xᵢ can be:

xᵢ=vᵢ−λ.

As shown in the above equation, a bid price for a particular auction element can be higher if the particular auction element is more valuable, or has a higher expected value. The expected value for the particular auction element vᵢ can be determined by historical data. For instance, the expected value can be an average of past revenue generated from impressions on ad spaces of the particular auction element.

Instead of calculating the multiplier λ deterministically, the bid prices xᵢ can be calculated iteratively. More particularly, a bidder may submit the bid prices xᵢ to respective auction elements for a first time period. The bidder (or other software components of the server system 122) can determine, for each auction element, the number of bids submitted during the first time period and the number of impressions served by creatives of the line item (i.e. bids won by the line item) during the first time period (235). Based on the number of bids submitted and the number of impressions served, the bid prices calculator 170 can determine an actual budget spending pace for the first time period. The bid prices calculator 170 can update the bid prices for the auction elements, for a second time period after the first time period (240), based on a target budget spending pace for the second time period (\tilde{S}) the actual budget spending pace for the first time period (S), and the bid prices for the first time period (xᵢ).

By way of illustration, the bid prices calculator 170 can update the bid prices for the second time period (after the first time period) by an adjustment amount δ:

λ:=λ−δ,

or

xᵢ:=xᵢ+δ.

The adjustment amount δ can be determined as follows:

$$If$$

$$\overline{x} > 0$$

$$and$$

$$W > 0 : δ = \overline{x} \cdot \frac{\tilde{W} - W}{W ( 1 - W )} , \\ else$$

$$δ = \tilde{W} - W$$

with the following constraint:

$$δ = min ( max ( δ , - \frac{\overline{x}}{2} ) , \overline{x} ) .$$

Here, W is the actual win rate, or actual spending pace S divided by a total number of bids submitted by the line item, for the first time period. \tilde{W} is the target win rate, or the expected spending pace \tilde{S} divided by a total number of ad spaces available for the line item to bid, for the second time period. The total number of ad spaces available for the line item to bid during the second time period can be assumed to be the same as the total number of bids submitted by the line item during the first time period. x̅ is the average bid price for the first time period. Here, the highest competing bids is assumed to have a log-logistic distribution. The actual win rate W could be zero if all bids are too low to win any auction.

In another implementation, the adjustment amount δ can be determined as follows:

$$δ = \overline{x} \cdot \frac{\tilde{S} - S}{\tilde{S} log \tilde{W}}$$

$$if$$

$$\tilde{S} \geq S$$

$$δ = \overline{x} \cdot \frac{\tilde{S} - S}{S log \tilde{W}}$$

$$if$$

$$\tilde{S} \geq S$$

Here, the win curve Fᵢ(xᵢ) is assumed to have a log-Gumbel shape.

In yet another implementation, the adjustment amount δ can be determined as follows:

$$δ = - ( \frac{\tilde{S}}{S} - 1 ) \cdot \overline{x}$$

Here, the win curve Fᵢ(xᵢ) can be assumed to be approximately linear, and zero when a bid price for a particular auction element is 0. x̅ is the average bid price for all auction elements.

The frequency to update bid prices (by the adjustment amount δ) can be based on one of the two conditions below:

impressions≧r·B

$$available\_ad \_spaces \geq \frac{r \cdot B}{\tilde{W}}$$

Here, B is the total budget. r is a given portion of the total budget (e.g., one percent of the total budget). The bid prices calculator 170 can update with a new set of bid prices when the number of impressions (i.e., bids won) has reached the given portion of the total budget in the current iteration, or when the given portion of the total budget should have been spent in the current iteration.

The target spending pace \tilde{S} can be derived as the remaining available budget R over the remaining lifetime (or time period) of the budget h:

$$\tilde{S} ( t ) = \frac{R ( t )}{h ( t )}$$

For instance, if the remaining daily budget is $600 at noon, then the budget spending pace can be $50 per hour. In some implementations, the budget spending pace S can depend on time of the day. For instance, if the remaining daily budget is $600 at noon, then the budget spending pace can be $37.5 per hour for the rest of the day, except between 7 to 11 o'clock in the evening (e.g., when people may go online more often), the budget spending pace is $75 per hour.

The bid prices calculator 170 can optimize toward a higher number of success events from impressions won by the line items (i.e., higher total revenue), or toward a higher margin from impressions won by the line items, by adjusting the expected value of an impression for the line items on the i-th auction element vᵢ as follows:

xᵢ=α·vᵢ−λ

Here, the parameter α (a lever or bias) can be greater than or equal to 0. When α is 1, the calculated bid prices are the same as above for optimizing a total revenue for the line item, thus enabling a higher number of success events from impressions served by creatives of the line item. When α is 0, all available ad spaces are bid on with the same bid price (regardless respective expected values) that can enable higher margin by buying more impressions from auction elements with lower expected values, and buying less impressions from auction elements with higher expected values.

When the parameter a is greater than 1, auction elements (or ad spaces) with higher expected values can be bid with bid prices higher than respective expected values, thus even more bias is given to the auction elements with higher expected values.

In some implementations, the bid prices calculator 170 can calculate bid prices for minimizing the overall media cost (bid prices paid) for a success event, or equivalently, for maximizing overall conversions (from impressions to success events) subject to a budget constraint in media cost. The bid prices calculator 170 can calculate bid prices for maximizing overall conversions subject to a budget constraint in media cost based on an expected number of success events from impressions on ad spaces of each auction element. Here, let pᵢ denote the probability of a conversion for a given impression on the i-th auction element. pᵢ is an expected number of success events on impressions served by creatives of the line items on the i-th auction element. Maximizing overall conversions for the line item can be represented by the following utility function:

$${\sum }_{i = 1}^{n} {E}_{i} \cdot {F}_{i} ( {x}_{i} ) \cdot {p}_{i} ,$$

subject to the constraint as follows:

$${\sum }_{i = 1}^{n} {E}_{i} \cdot {F}_{i} ( {x}_{i} ) \cdot {c}_{i} ( {x}_{i} ) = S .$$

Assuming a second-price auction and the expected cost on an impression for a given bid price cᵢ (xᵢ) being the expected value of the second highest bid when the given bid price wins the auction as described earlier, and applying the method of Lagrange multipliers, the optimal bid price can be:

$${x}_{i} = \frac{{p}_{i}}{λ}$$

Note that the bid price is higher when the auction element has higher probable conversion rate. The multiplier λ (thus the bid prices xᵢ) can be adjusted for a second time period after a first time period, as follows:

$$λ \text{:} λ - λ \cdot \frac{\tilde{S} - S}{S}$$

$$if$$

$$\tilde{S} \geq S$$

$$λ \text{:} λ - λ \cdot \frac{\tilde{S} - S}{S}$$

$$if$$

$$\tilde{S} \geq S$$

or equivalently:

$$λ \text{:} λ \cdot \frac{S}{\tilde{S}}$$

$$if$$

$$\tilde{S} \geq S$$

$$λ \text{:} λ \cdot ( 2 - \frac{\tilde{S}}{S} )$$

$$if$$

$$\tilde{S} \geq S$$

As described earlier, \tilde{S} is the target budget spending pace for the second time period. S is the actual budget spending pace for the first time period.

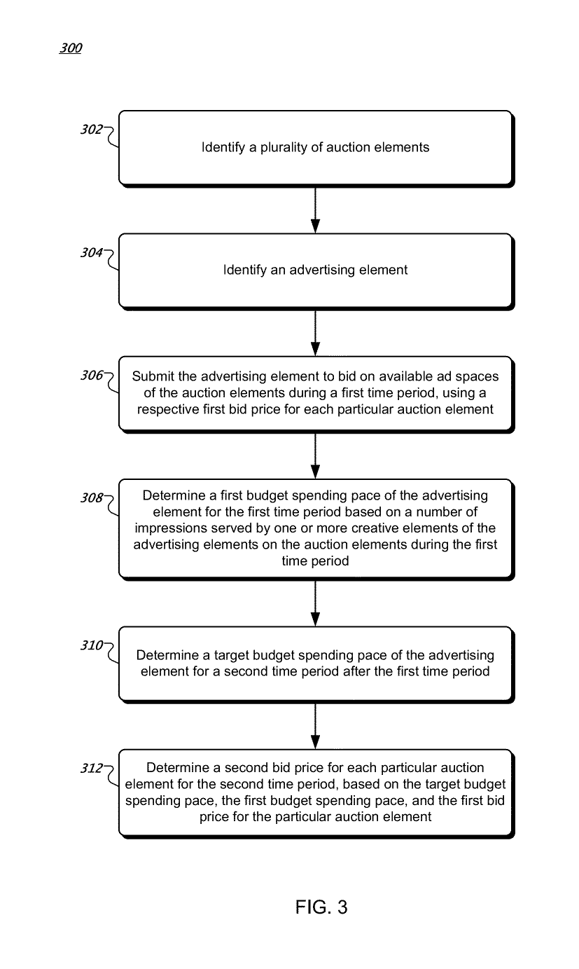

FIG. 3 is a flow chart of an example method for adjusting bid prices for online advertising auctions. The method can be implemented using software components executing on one or more data processing apparatus that are part of the data center 121 described earlier. The method begins by identifying a plurality of auction elements, each auction element comprising one or more ad spaces on web pages (302). The method identifies an advertising element, the advertising element comprising an advertiser and one or more campaigns, each campaign comprising one or more creative elements (304). The method submits the advertising element to bid on available ad spaces of the auction elements during a first time period, using a respective first bid price for each particular auction element (306). The method determines a first budget spending pace of the advertising element for the first time period based on a number of impressions served by one or more creative elements of the advertising element on the auction elements during the first time period (308). The method determines an target budget spending pace of the advertising element for a second time period after the first time period (310). The method determines a second bid price for each particular auction element for the second time period, based on the target budget spending pace, the first budget spending pace, and the first bid price for the particular auction element (312).

Implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language resource), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending resources to and receiving resources from a device that is used by the user; for example, by sending web pages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method for adjusting an advertising budget spending pace, the method comprising:
identifying a plurality of auction elements, each auction element comprising one or more ad spaces on web pages;
identifying an advertising element, the advertising element comprising an advertiser and one or more campaigns, each campaign comprising one or more creative elements;
submitting the advertising element to bid on available ad spaces of the auction elements during a first time period, using a respective first bid price for each particular auction element;
determining a first budget spending pace of the advertising element for the first time period based on a number of impressions served by one or more creative elements of the advertising element on the auction elements during the first time period;
determining a target budget spending pace of the advertising element for a second time period after the first time period; and
determining a second bid price for each particular auction element for the second time period, based on the target budget spending pace, the first budget spending pace, and the first bid price for the particular auction element,
wherein identifying, submitting, and determining are performed by one or more computer processors.

2. The method of claim 1, wherein a second bid price for each particular auction element for the second time period is determined further based on an adjustment providing more weight to a first condition or a second condition, wherein:
a first condition is configured to enable, with the second bid price, a higher number of success events from impressions served by one or more creative elements of the advertising element on the auction elements during the second time period; and
a second condition is configured to enable, with the second bid price, a higher margin from impressions served by one or more creative elements of the advertising element on the auction elements during the second time period.

3. The method of claim 1, wherein the target budget spending pace is determined based on a remaining budget and remaining effective duration of the advertising element after the first time period.

4. The method of claim 1, wherein the target budget spending pace is determined based on time of day of the second time period.

5. The method of claim 1, wherein determining a second bid price for each particular auction element for the second time period is further based on an expected revenue generated from success events on impressions served by one or more creative elements of the advertising element on the particular auction element.

6. The method of claim 1, wherein determining a second bid price for each particular auction element for the second time period is further based on an expected number of success events on impressions served by one or more creative elements of the advertising element on the particular auction element.

7. The method of claim 1, wherein a particular success event is a click event or click-through event.

8. A system comprising one or more computer processors programmed to perform operations comprising:
identifying a plurality of auction elements, each auction element comprising one or more ad spaces on web pages;
identifying an advertising element, the advertising element comprising an advertiser and one or more campaigns, each campaign comprising one or more creative elements;
submitting the advertising element to bid on available ad spaces of the auction elements during a first time period, using a respective first bid price for each particular auction element;
determining a first budget spending pace of the advertising element for the first time period based on a number of impressions served by one or more creative elements of the advertising element on the auction elements during the first time period;
determining a target budget spending pace of the advertising element for a second time period after the first time period; and
determining a second bid price for each particular auction element for the second time period, based on the target budget spending pace, the first budget spending pace, and the first bid price for the particular auction element.

9. The system of claim 8, wherein a second bid price for each particular auction element for the second time period is determined further based on an adjustment providing more weight to a first condition or a second condition, wherein:
a first condition is configured to enable, with the second bid price, a higher number of success events from impressions served by one or more creative elements of the advertising element on the auction elements during the second time period; and
a second condition is configured to enable, with the second bid price, a higher margin from impressions served by one or more creative elements of the advertising element on the auction elements during the second time period.

10. The system of claim 8, wherein the target budget spending pace is determined based on a remaining budget and remaining effective duration of the advertising element after the first time period.

11. The system of claim 8, wherein the target budget spending pace is determined based on time of day of the second time period.

12. The system of claim 8, wherein determining a second bid price for each particular auction element for the second time period is further based on an expected revenue generated from success events on impressions served by one or more creative elements of the advertising element on the particular auction element.

13. The system of claim 8, wherein determining a second bid price for each particular auction element for the second time period is further based on an expected number of success events on impressions served by one or more creative elements of the advertising element on the particular auction element.

14. The system of claim 8, wherein a particular success event is a click event or click-through event.

15. A computer storage medium having instructions stored thereon that, when executed by data processing apparatus, cause the data processing apparatus to perform the following operations:
identifying a plurality of auction elements, each auction element comprising one or more ad spaces on web pages;
identifying an advertising element, the advertising element comprising an advertiser and one or more campaigns, each campaign comprising one or more creative elements;
submitting the advertising element to bid on available ad spaces of the auction elements during a first time period, using a respective first bid price for each particular auction element;
determining a first budget spending pace of the advertising element for the first time period based on a number of impressions served by one or more creative elements of the advertising element on the auction elements during the first time period;
determining a target budget spending pace of the advertising element for a second time period after the first time period; and
determining a second bid price for each particular auction element for the second time period, based on the target budget spending pace, the first budget spending pace, and the first bid price for the particular auction element.

16. The computer storage medium of claim 15, wherein a second bid price for each particular auction element for the second time period is determined further based on an adjustment providing more weight to a first condition or a second condition, wherein:
a first condition is configured to enable, with the second bid price, a higher number of success events from impressions served by one or more creative elements of the advertising element on the auction elements during the second time period; and
a second condition is configured to enable, with the second bid price, a higher margin from impressions served by one or more creative elements of the advertising element on the auction elements during the second time period.

17. The computer storage medium of claim 15, wherein the target budget spending pace is determined based on a remaining budget and remaining effective duration of the advertising element after the first time period.

18. The computer storage medium of claim 15, wherein the target budget spending pace is determined based on time of day of the second time period.

19. The computer storage medium of claim 15, wherein determining a second bid price for each particular auction element for the second time period is further based on an expected revenue generated from success events on impressions served by one or more creative elements of the advertising element on the particular auction element.

20. The computer storage medium of claim 15, wherein determining a second bid price for each particular auction element for the second time period is further based on an expected number of success events on impressions served by one or more creative elements of the advertising element on the particular auction element.

21. The computer storage medium of claim 15, wherein a particular success event is a click event or click-through event.
